(19) United States
(12) Patent Application Publication
(10) Pub. No.: US 2014/0117875 A1
(43) Pub. Date: May 1, 2014

(54) SYSTEMS AND METHODS TO WIRELESSLY CONTROL ILLUMINATION CHARACTERISTICS OF WEARABLE ITEMS

(71) Applicant: Illuminvent, LLC, New York, NY (US)

(72) Inventor: Michael Kane, Ann Arbor, MI (US)

(73) Assignee: Illuminvent, LLC, New York, NY (US)

(21) Appl. No.: 14/062,499

(22) Filed: Oct. 24, 2013

Related U.S. Application Data
(60) Provisional application No. 61/718,848, filed on Oct. 26, 2012.

(51) Int. Cl. H05B 33/08

(52) U.S. Cl. CPC H05B 33/0842
USPC 315/291

(57) ABSTRACT

Systems, apparatuses, and methods are provided that include wireless control of output characteristics. Such systems, apparatuses, and methods may include wearable items and such controllable output characteristics may relate to illumination characteristics. In one example, a wearable item includes a receiver, a power source, an illumination device adapted to illuminate a first color and a second color different than the first color, and a processor in communication with the receiver, the power source, and the illumination device. The receiver is adapted to receive a signal and communicate the signal to the processor. The processor is configured to illuminate the illumination device in one of the first color and the second color based on the signal received by the receiver.

### CROSS-REFERENCE TO RELATED APPLICATION

This application is related to and claims priority to U.S. Provisional Patent Application Ser. No. 61/718,848, filed Oct. 26, 2012, entitled “SYSTEMS AND APPARATUSES ADAPTED TO WIRELESSLY CONTROL ILLUMINATION CHARACTERISTICS OF WEARABLE ITEMS AND METHODS OF PERFORMING SUCH CONTROL,” the entirety of which is incorporated herein by reference.

### STATEMENT REGARDING FEDERALLY SPONSORED RESEARCH OR DEVELOPMENT

n/a

### FIELD OF THE INVENTION

The present invention generally relates to systems and apparatuses including at least one illumination device and, more particularly, to systems and apparatuses including at least one illumination device on a wearable item that may be altered wirelessly.

### SUMMARY OF THE INVENTION

In one example, a wearable item is provided and includes a receiver, a power source, an illumination device adapted to illuminate a first color and a second color different than the first color, and a processor in communication with the receiver, the power source, and the illumination device. The receiver is adapted to receive a signal and communicate the signal to the processor, and the processor is configured to illuminate the illumination device in one of the first color and the second color based on the signal received by the receiver.

In another example, a system is provided and includes a wearable item and a communication device. The wearable item includes a receiver, a power source, an illumination device electrically coupled to the power source, and a processor in communication with the receiver, the power source, and the illumination device. The communication device includes a power source, a transmitter, and a processor in communication with the power source and the transmitter. The communication device is adapted to transmit a signal via the transmitter that is associated with operation of the illumination device, and wherein the receiver is adapted to receive the signal and the processor of the wearable item is adapted to control the illumination device in accordance with the signal.

In a further example, an apparatus is provided and includes a receiver, a power source, an illumination device including a first illumination condition and a second illumination condition different than the first illumination condition, and a processor in communication with the receiver and the illumination device, wherein the receiver is adapted to receive a signal containing data for determining operability of the illumination device, and wherein the processor illuminates the illumination device in one of the first illumination condition and the second illumination condition based on the signal received by the receiver.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of an exemplary product;

FIG. 2 is a diagram of an exemplary system, the system including an exemplary communication device and the exemplary product illustrated in FIG. 1;

FIG. 3 is a diagram of another exemplary product including both an input device and a receiver enabling both manual control and wireless control of the product;

FIG. 4 is a diagram of another exemplary system, the system including an exemplary communication device and a plurality of exemplary products comprised of, in any combination, one or more of the exemplary products shown in FIGS. 1 and 3;

FIG. 5 is a diagram of an exemplary product or communication device including an exemplary transceiver;

FIG. 6 is a front view of a further exemplary product illustrated in a non-illuminated condition;

FIG. 7 is an enlarged view of a portion of the product shown in FIG. 6;

FIG. 8 is a top perspective view of an exemplary controller interface of the product shown in FIG. 6;

FIG. 9 is a front view of the product shown in FIG. 6 in an illuminated condition;

FIG. 10 is an exemplary system including the product shown in FIG. 6 along with a wireless communication device;

FIG. 11 is a screen shot of a portion of an exemplary manner of creating a software application operable to be executed on a wireless communication device; and

FIG. 12 is another view of the system shown in FIG. 10.

Before any independent features and embodiments of the invention are explained in detail, it is to be understood that the invention is not limited in its application to the details of the construction and the arrangement of the components set forth in the following description or illustrated in the drawings. The invention is capable of other embodiments and of being practiced or of being carried out in various ways. Also, it is understood that the phraseology and terminology used herein is for the purpose of description and should not be regarded as limiting.

### DETAILED DESCRIPTION OF THE INVENTION

With the advancement of electronics, users of the electronics are becoming more savvy and have more of a desire to participate in product control. In some aspects of the present invention, users of electronic devices and products have the capability of controlling the operation and performance of such electronic devices and products, and further provides a wide variety of products with capabilities not previously contemplated. Moreover, advancement of electronic technologies allows new manners of controlling operation of the electronics.

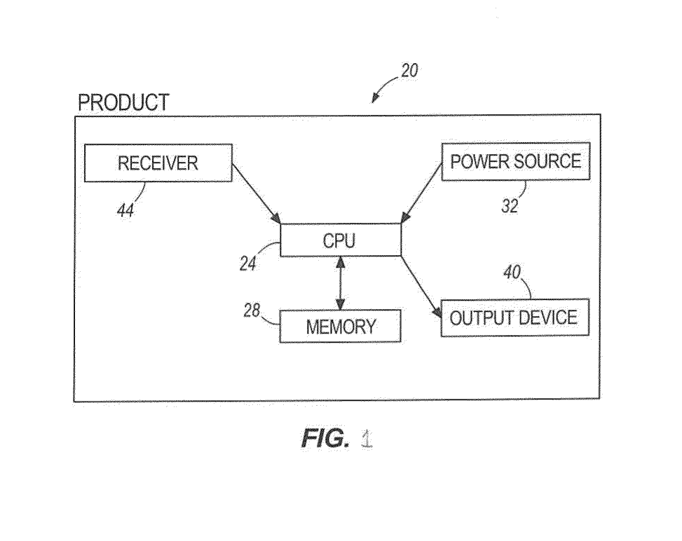

Many types of apparatuses or products 20 are possible in the present invention. Some of these products 20 are electronics, while other products 20 are not typically electrical in nature, but have electronics incorporated therein for the present invention. In some exemplary embodiments, a wide variety of products 20, both those typically characterized as electronic in nature and those not previously characterized as electronic in nature, include a central processing unit (CPU) 24, memory 28, an onboard power source 32, an output device 40, and a receiver 44 (see FIG. 1).

The following examples of products 20 are provided for exemplary purposes and are not intended to be limiting upon the present invention. Rather, the present invention is capable of including any product 20 and all of such possibilities are intended to be within the spirit and scope of the present invention. For example, products 20 may include: footwear (e.g., sneakers, rollerblades, ice skates, flip-flops, sandals, etc.); headwear (e.g., caps, hats, headbands, etc.); apparel (e.g., shirts, pants, jackets, shorts, bodysuits; etc.); jewelry (e.g., watches, wristlets, earrings, necklaces, broaches, pins, etc.); other wearable items (e.g., wristbands, armbands, handkerchiefs, do-rags, etc.); accessories (e.g., eye glasses, sun glasses, bags, handbags, luggage, backpacks, briefcases, belts, suspenders/braces, glow sticks, holiday lights, etc.); furniture (e.g., sofa, chair, table, entertainment system, desk, etc.); automobiles (e.g., cars, trucks, motorcycles, mopeds, motorbikes, all-terrain vehicles (ATV); etc.); unicycles; bicycles; tricycles; consumer electronics (e.g., telephones, wireless communication devices, cellular phones, iPhones®, Blackberrys®, other smartphones, iPad®, other tablets, handheld and stationary video game consoles, personal computers, laptops, headphones, video displays, projectors, audio or sound systems, speakers, scent generators, environmental control systems, electric fans, liquid misting machines, smoke or fog generators, etc.); structural and building materials (e.g., floor tiles, materials for facades of buildings, walls, door frames, doors, etc.); appliances (e.g., refrigerator/freezer, stove, oven, blender, microwave, etc.); license plate frames; tire rims; picture frames; etc. As one will ascertain upon reading and understanding the present invention, the applications and products to which the present invention applies is quite vast, thus making it difficult to identify every possible application and product herein. Therefore, it should be understood that the principles of the present invention apply to every appropriate application and product known to date and those appropriate applications and products yet to exist.

The CPU 24 is capable of performing the necessary functions to carryout desired operability of the product 20 and communicates with the memory 28 as needed. An onboard power source 32 provides the product 20 with the necessary power and, particularly, the CPU 24 with necessary power to perform the desired operability of the product 20. The CPU 24 may be any appropriate type of CPU in order to perform the desired operability of the product 20. The memory 28 may be RAM, ROM, a combination thereof or any other type of memory in order to facilitate desired operation of the product 20. The onboard power source 32 may be any type of power source such as, for example, any type of battery, solar power cell, fuel cell, other AC or DC power sources, or any other type of power source that provides the necessary power for operation of the product 20.

The output device 40 is capable of being a wide variety of output devices such as, for example: an illumination device (e.g., light emitting diode (LED), organic LED (OLED), printed electronics with illumination devices, embedded electronics with illumination devices, electroluminescent devices, quantum dots, etc.); a speaker; a vibration generating device; an environmental control system; a video display or monitor; etc.

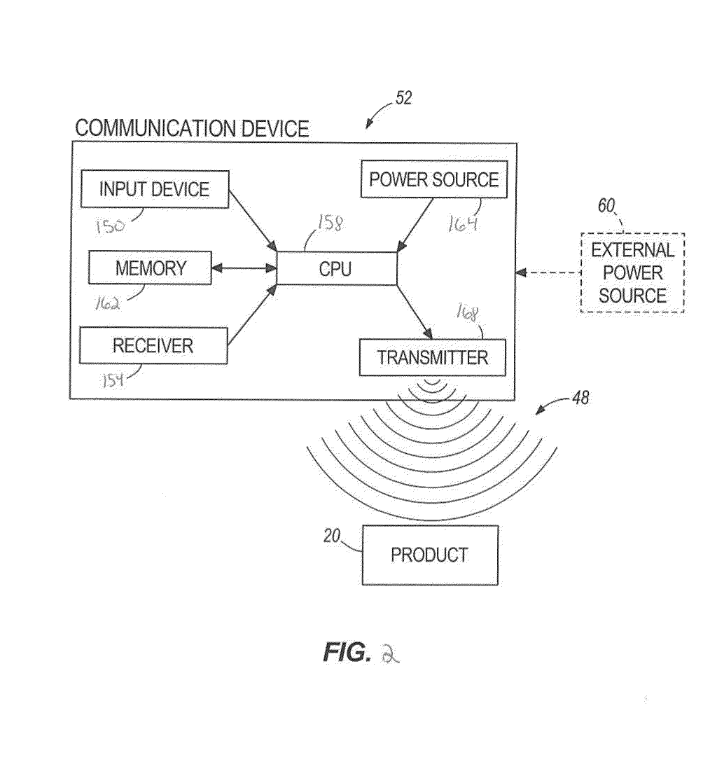

With continued reference to FIG. 1, the receiver 44 is adapted to receive a signal 48 or signals 48 from a wireless communication source or device 52 (see FIG. 2). The signal 48 may be in any form such as, for example, Bluetooth, wireless TCP/IP, cellular, Wi-Fi, etc., and the communication source 52 may be any type of communication source 52 such as, for example, a cellular phone, smartphone, tablet, personal computer, laptop, sensor, an interactive entertainment device (e.g., GoogleTV, any other smart television or television with interactive capabilities, and any other smart or interactive device compatible with a television), etc. The signal 48 includes data with instructions on how to operate the output device 40. The CPU 24 processes the data and controls operation of the output device 40. In the illustrated exemplary embodiment, the product 20 includes a single receiver 44 and a single output device 40, however, it should be understood that the product 20 is capable of including any number of receivers 44 and any number of output devices 40 and be within the intended spirit and scope of the present invention.

Communication with the product 20 via the receiver 44 provides a user with the ability to adjust operation of the output device 40. In some examples, a product 20 may be provided from a factory with an initial operation and the user is capable of adjusting the product 20 to a second operation different than the initial operation via sending communications to the receiver 44. The user is also capable of adjusting the operation of the product 20 between any number of different operations and may make such adjustments an unlimited amount of times.

With reference to FIG. 2, an exemplary system is illustrated and includes an exemplary communication device 52 and an exemplary product 20. The system provides a user with the ability to adjust or alter operation of a product 20 and, more particularly, adjust or alter an output of the product 20. In this exemplary embodiment, the product 20 may be similar to the product 20 illustrated in FIG. 1. Alternatively, the product 20 illustrated in FIG. 2 may be different than the product 20 illustrated in FIG. 1 as long as the product 20 includes a receiver 44 for receiving signals 48 from a communication device 52. The communication device 52 may be any type of communication device 52 such as, for example, a cellular phone, a smartphone, a tablet, a personal computer, a laptop computer, etc., and may include an input device 150, a receiver 154, a CPU 158, memory 162, a power source 164, and a transmitter 168. The input device 150 may be any of the types of input devices 150 described above in connection with the product 20 illustrated in FIG. 1, alternatives thereof, or other input devices not described herein but within the intended spirit and scope of the present invention.

A user may manipulate the input device 150 of the communication device 52 or otherwise facilitate a signal 48 being sent to the communication device 52 for receipt by the receiver 44 in order to initiate a process for adjusting or altering operation of the product 20. The CPU 158 communicates with either or both of the input device 150 and the receiver 154 to receive the proper signal and instructions. The CPU 158 communicates with the memory 162 as needed to achieve the desired operation of the system and receives the necessary power from the power source 164. The system may additionally include an external power source such as, for example, an alternating current (AC) power source (e.g., a power cord coupled to an electrical wall outlet) if such a power source 60 is needed or when such a power source 60 is available. The CPU 158 communicates with the transmitter 168, which in turn transmits a signal 48 including the desired manner of operating the product 20. The product 20 receives the signal 48 and processes the signal 48 in manners similar to those described above in connection with the product 20 shown in FIG. 1. A user may alter or adjust the operation of the product 20 between any number of different operations and may make such adjustments as many times as desired via the communication device 52.

The following are exemplary products 20 and exemplary processes of adjusting the operation of the exemplary products 20. Neither the exemplary products 20 nor the exemplary adjusting processes are intended to be limiting. Rather, any product and any process of adjusting may be utilized and be within the intended spirit and scope of the present invention.

In some exemplary embodiments, the product 20 may be a shirt including a receiver 44, a CPU 24, memory 28, an onboard power source 32, and an illumination device as the output device 40. A user may send a signal 48 to the shirt 20 from a communication device 52. The receiver 44 on the shirt 20 will receive the signal 48, and the CPU 24 will process the signal 48 and the data included therein. The CPU 24 will then control the illumination device 40 in a first operation. The first operation of the illumination device 40 may include illuminating the illumination device 40 a first color, pulsating the illumination device 40 at a first rate, etc. A user may then send a second signal 48 to the shirt 20 from the communication device 52. The receiver 44 on the shirt 20 receives the second signal 48 and the CPU 24 processes the second signal 48 and the data included therein. The CPU 24 then controls the illumination device 40 in a second operation different than the first operation. Adjusting from the first operation to the second operation of the illumination device 40 may include changing the color of the illumination device 40, changing the pulsating rate of the illumination device 40, changing both color and pulsating rate of the illumination device 40, changing the intensity of illumination, or changing any other characteristic of the illumination device 40. This exemplary embodiment describes a single illumination device 40. However, the product 20 is capable of including a plurality of illumination devices 40 and the user may send signals 48 to the receiver 44 of the product 20 to change operation of the plurality of illumination devices 40. Such changes in operation of the plurality of illumination devices 40 may include those changes described above in connection with a single illumination device 40 and additionally may include changing the pattern of flashing/pulsating of the illumination devices 40, changing direction of the flashing/pulsating of the illumination devices 40, changing the intensity of illumination of the illumination devices 40, or changing any other characteristics of the plurality of illumination devices 40.

In some exemplary embodiments, the product 20 may be a body suit including a receiver 44, a CPU 24, memory 28, an onboard power source 32, and a plurality of illumination devices as the output devices 40. Some of the illumination devices 40 may be supported on an upper body portion of the body suit 20 while other illumination devices 40 may be supported on a lower body portion of the body suit 20. A user may send a signal 48 to the body suit 20 from a communication device 52. The receiver 44 on the body suit 20 will receive the signal 48, and the CPU 24 will process the signal 48 and the data included therein. The CPU 24 will then control the illumination devices 40 in a first operation. The first operation of the illumination devices 40 may include illuminating the illumination devices 40 on the upper body portion the same as the illumination devices 40 on the lower body portion, illuminating the illumination devices 40 differently on the upper body portion and the lower body portion, etc. For example, illumination devices 40 on an arm portion of the body suit 20 may flash one color and at one rate and illumination devices 40 on a leg portion of the body suit 20 may flash a different color and at a different rate. A user may then send a second signal 48 to the body suit 20 from the communication device 52. The receiver 44 on the body suit 20 receives the second signal 48 and the CPU 24 processes the second signal 48 and the data included therein. The CPU 24 then controls the illumination devices 40 in a second operation different than the first operation. Adjusting from the first operation to the second operation of the illumination devices 40 may include changing the color of the illumination devices 40, changing the flashing/pulsating rate of the illumination devices 40, changing both color and pulsating rate of the illumination devices 40, changing direction of the flashing/pulsating of the illumination devices 40, changing the intensity of illumination, or changing any other characteristic of the illumination devices 40.

In other exemplary embodiments, the product may include a variety of different apparel items, each of which includes one or more illumination devices as the output devices. For example, the apparel items may include a hat, a shirt, and shoes. A user may alter the illumination characteristics of the apparel via wireless communication with a wireless communication device.

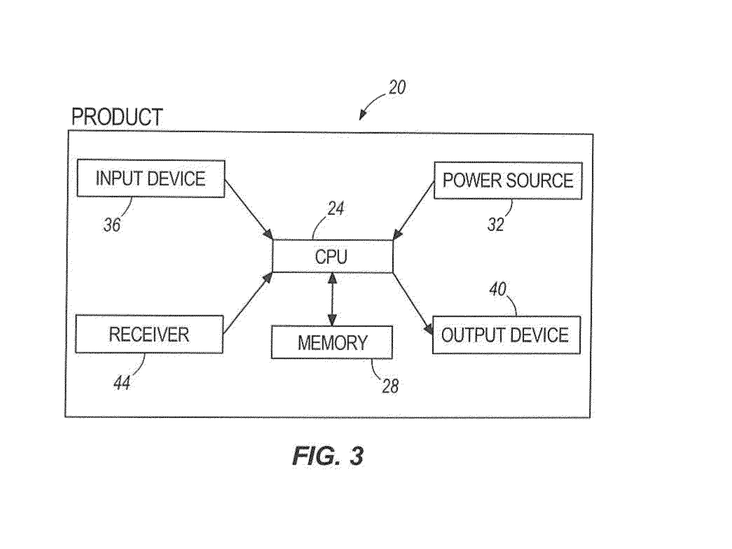

It should be understood that the product illustrated in FIG. 1 may include both an input device and a receiver (see for example FIG. 3). The product 20 illustrated in FIG. 3 is capable of being manipulated manually via the input device 36 and is adapted to receive a signal 48 or signals 48 from a wireless communication source 52 via the receiver 44. Thus, a user may adjust operability of the product 20 illustrated in FIG. 3 in more than one manner. The exemplary product 20 illustrated in FIG. 3 is adapted to be utilized in the exemplary system illustrated in FIG. 2.

The following examples of input devices 36 are provided for exemplary purposes and are not intended to be limiting. Rather, the product 20 is capable of having any input device and all of such possibilities are intended to be within the spirit and scope of the present invention. For example, the input device 36 may be: a mechanical actuator (e.g., rotatable knob, sliding knob, sliding switch, flip switch, etc.); keyboard; mouse; touch screen; sensor; etc. The input device 36, the receiver 44, and the output device 40 of the product 20 illustrated in FIG. 3 are capable of being any of the types of input devices 36, receivers 44, and output devices 40 described herein, any alternatives thereof, or any other input devices, receivers, and output devices not described herein, but intended to be within the spirit and scope of the present invention.

In the illustrated exemplary embodiment, the product 20 includes a single input device 36, a single receiver 44, and a single output device 40, however, it should be understood that the product 20 is capable of including any number of input devices 36, receivers 44, and output devices 40, and be within the intended spirit and scope of the present invention.

The input device 36 and communication with the product 20 via the receiver 44 provide a user with the ability to adjust operation of the output device 40 in multiple manners. In some examples, the product 20 may be provided from a factory with an initial operation and the user is capable of adjusting the product 20 to a second operation different than the initial operation either by adjusting the input device 36 or via sending communications to the receiver 44. The user is also capable of adjusting the operation of the product 20 between any number of different operations and making such adjustments an unlimited amount of times.

In some exemplary embodiments, the product 20 may be a shirt including a mechanical keypad as the input device 36, a CPU 24, memory 28, a power source 32, an illumination device as the output device 40, and a receiver 44. The user has the ability to alter operation of the illumination device 40 by either the mechanical keypad 36 or a wireless communication device 52 via one or more signals 48 sent to the receiver 44. If a user decides to utilize the input device 36, a user may perform a first keystroke or a first series of keystrokes on the keypad 36 to establish a first operation of the illumination device 40. The first operation of the illumination device 40 may include illuminating the illumination device 40 a first color, pulsating the illumination device 40 at a first rate, etc. A user may then perform a second keystroke or a second series of keystrokes on the keypad 36 to adjust operation of the product 20 from the first operation to a second operation different than the first operation. Alternatively, a user may select a first operation on a wireless communication device 52 and a signal corresponding to the first operation is sent to and received by the receiver 44. The CPU 24 then receives and controls operation of the illumination device 40 in accordance with the signal. A user then may decide to control the illumination device 40 in a second operation. A user then selects a second operation on the wireless communication device 52 and a second signal corresponding to the second operation is sent to and received by the receiver 44. The CPU 24 then receives and controls operation of the illumination device 40 in accordance with the second signal. Further yet, a user may decide to alter operation of the product 20 with both manually and wirelessly. The user may select a first operation either manually or wirelessly then alter operation of the product 20 to a second operation by the other manner. Adjusting from the first operation to the second operation of the illumination device 40 either manually or wirelessly may include changing the color of the illumination device 40, changing the pulsating rate of the illumination device 40, changing both color and pulsating rate of the illumination device 40, changing the intensity of the illumination, or changing any other characteristic of the illumination device 40. This exemplary embodiment describes a single illumination device 40. However, the product 20 is capable of including a plurality of illumination devices 40 and the input device 36 may be manipulated or signals sent via the communication device 52 to change operation of the plurality of illumination devices 40. Such changes in operation of the plurality of illumination devices 40 includes those changes described above in connection with a single illumination device 40 and additionally may include changing the pattern of flashing/pulsating of the illumination devices 40, changing direction of the flashing/pulsating of the illumination devices 40, changing the intensity of the illumination, or changing any other characteristics of the plurality of illumination devices 40.

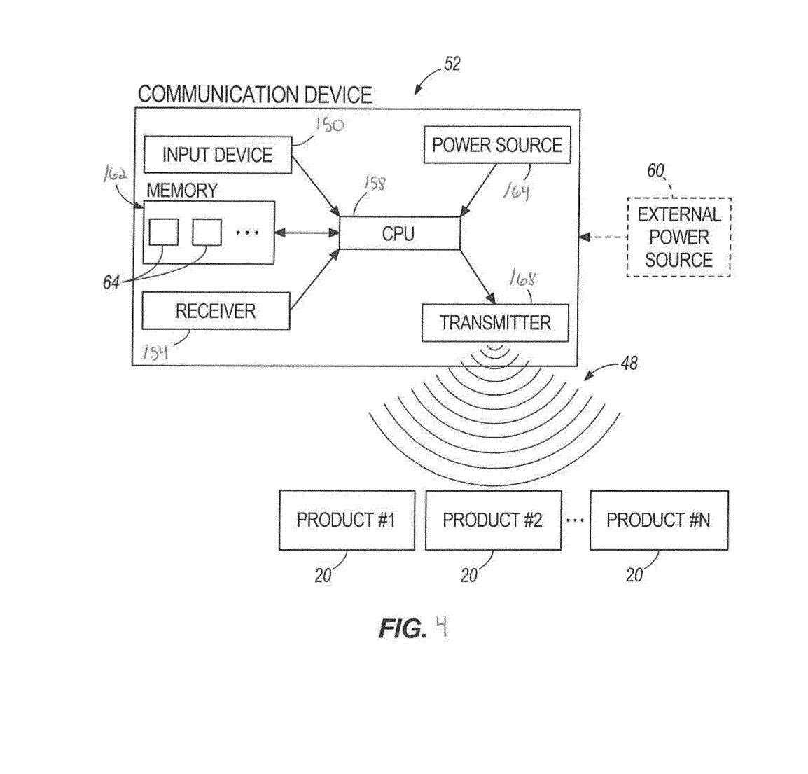

Referring now to FIG. 4, another exemplary system of the present invention is illustrated and includes an exemplary communication device 52 and a plurality of exemplary products 20. The system provides a user with the ability to adjust or alter operation of a plurality of products 20 and, more particularly, adjust or alter outputs of the products 20. In this exemplary embodiment, the products 20 may be similar to the products 20 illustrated in FIGS. 1-3. Alternatively, the products 20 illustrated in FIG. 4 may be different than those products 20 illustrated in FIGS. 1-3 as long as the products 20 include a receiver 44 for receiving signals 48 from a communication device 52. Also, in this exemplary embodiment, the communication device 52 may be similar to the communication device 52 illustrated in FIG. 2. Alternatively, the communication device 52 in FIG. 4 may be different than the communication device 52 illustrated in FIG. 2 as long as the communication device 52 includes a transmitter 168 and may be manipulated by a user to emit signals including instructions to products 20 via the transmitter 168.

A user may manipulate the input device 150 of the communication device 52 or may facilitate a signal 48 being sent to the communication device 52 for receipt by the receiver 44 in order to initiate a process for adjusting or altering operation of the products 20. The CPU 158 communicates with either or both of the input device 150 and the receiver 154 to receive the proper instructions. The CPU 158 communicates with the memory 162 as needed to achieve the desired operation of the system and receives the necessary power from the power source 164. The system may additionally include an external power source 60 such as, for example, an alternating current (AC) power source (e.g., a power cord coupled to an electrical wall outlet) if such a power source 60 is needed or when such a power source 60 is available. The CPU 158 communicates with the transmitter 168, which in turn transmits a signal 48 or a plurality of signals 48 including all the operating instructions for all the products 20. The products 20 receive their instructions from the signal or plurality of signals 48 and process the signal(s) 48. A user may alter or adjust the operation of the products 20 between any number of different operations and may make such adjustments as many times as desired via the communication device 52.

In one example, an exemplary system may include a tablet as the communication device 52, a jacket as the first product 20, and a hat as the second product 20. The tablet 52 may include similar components as the communication device 52 illustrated in FIG. 4. The tablet 52 may also include a downloadable software program or application (“APP”) stored thereon in the memory 162 that facilitates adjustment of the operation of the first and second products 20. The hat 20 may be similar to one of the products 20 illustrated in FIGS. 1-3 with the hat 20 including a receiver 44 to communicate with the communication device 52 and an illumination device as the output device 40. The tablet 52 may include a touch screen as the input device 150 and a user may initiate adjustment of the operation of the two products 20 by initiating and running the APP on the tablet 52. The CPU 158 of the tablet 52 processes the APP, receives the instructions provided by the user via the touch screen 150, and emits one or more signals 48 to the first and second products 20. The first and second products 20 receive the signal(s) 48 via their receivers 44, the CPUs 24 on the first and second products 20 process the instructions sent via the signal(s) 48, and the output devices 40 of the first and second products 20 operate in accordance with the instructions.

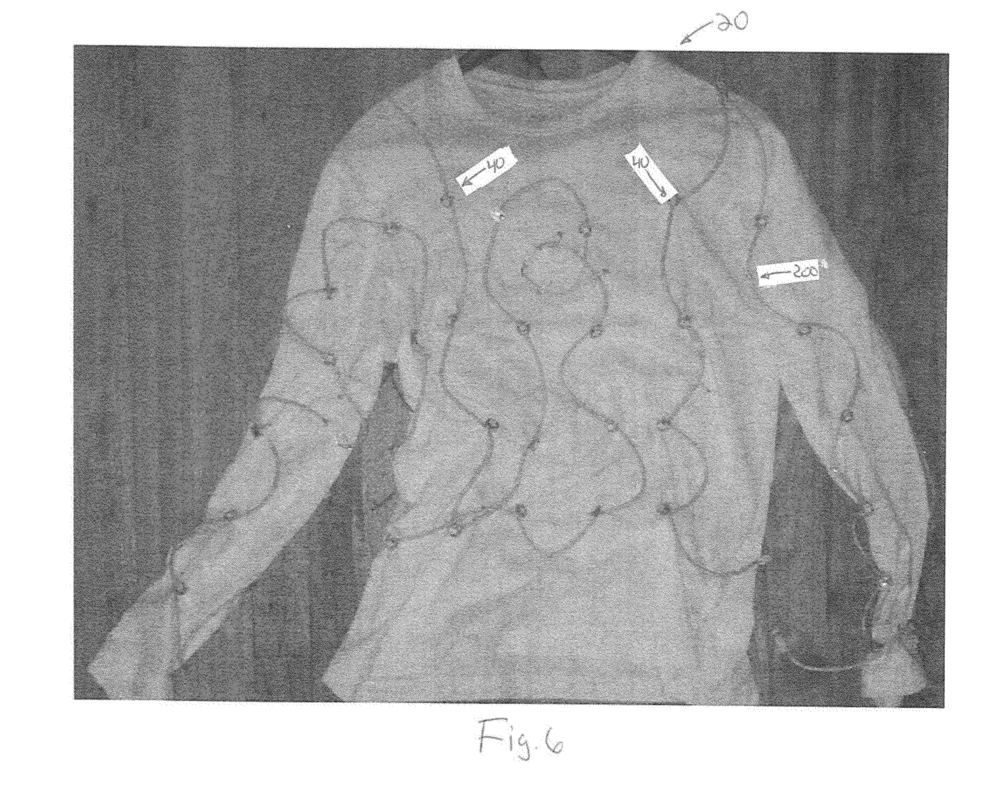

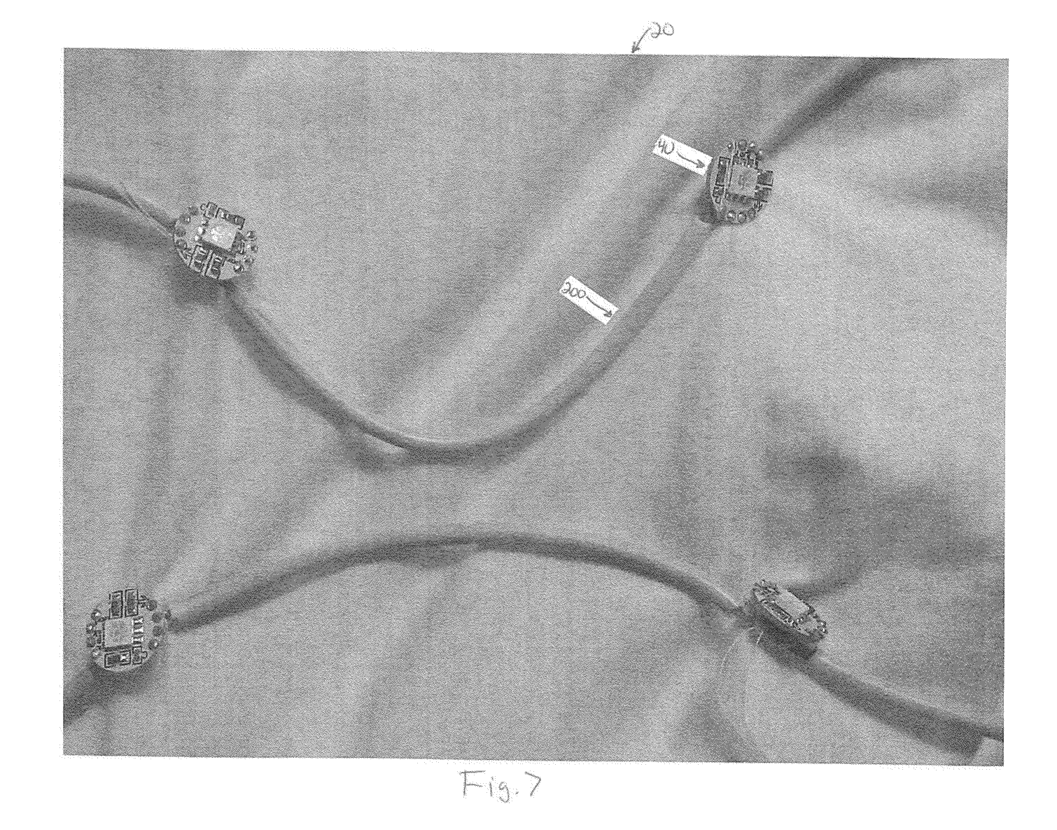

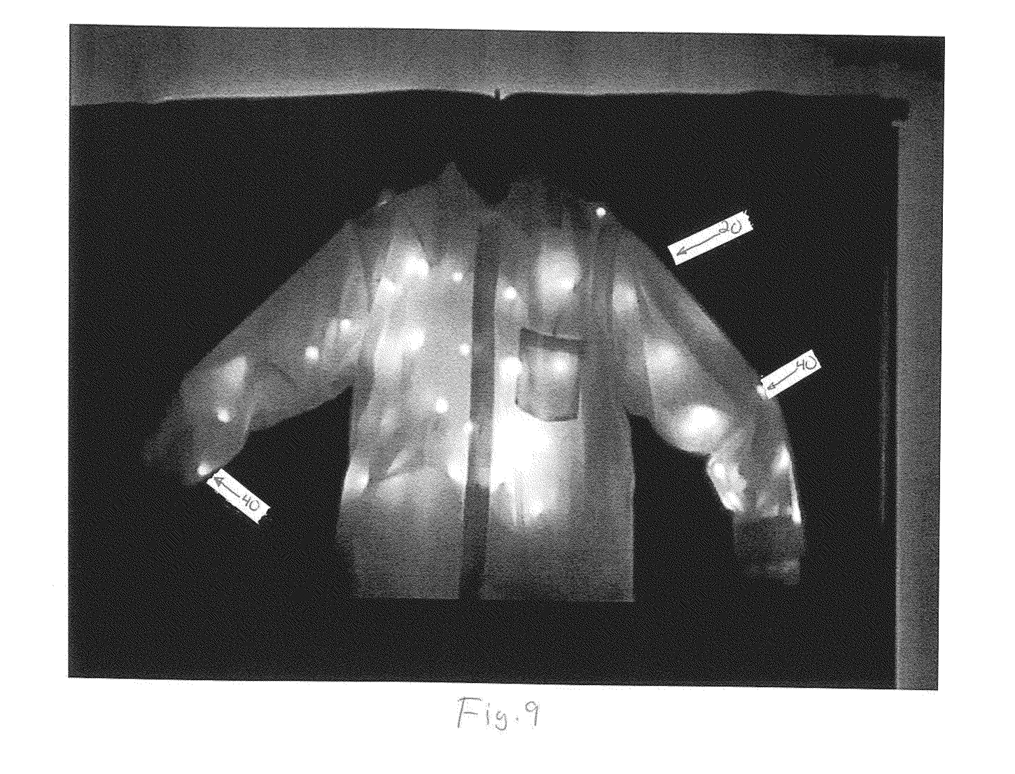

In a further example, with reference to FIGS. 6-12, another exemplary system is illustrated including a product 20 and a wireless communication device 52. In the illustrated exemplary embodiment, the product is a shirt 20. However, the product 20 is capable of being any type of product listed above or alternatives thereof. Also, in the illustrated exemplary embodiment, the wireless communication device 52 is a smartphone such as, for example, an Android enabled smart phone 52. However, the wireless communication device 52 is capable of being any type of communication device listed above or alternatives thereof.

The shirt 20 includes a plurality of output devices 40 soldered to electrical wires 200, thereby facilitating electrical communication to all the output devices 40. In the illustrated exemplary embodiment, the output devices are illumination devices 40 and, more particularly, LEDs. The LEDs 40 may be a wide variety of different types of LEDs such as, for example, LED chips, Bliptronics LED pixels, etc. The system is capable of including any type of illumination device and all of such possibilities are intended to be within the spirit and scope of the present invention. The illumination devices 40 and associated wires 200 may be coupled to the shirt 20 in a variety of different manners. In one exemplary manner, the illumination devices 40 and wires 200 may be sewn into the shirt 20.

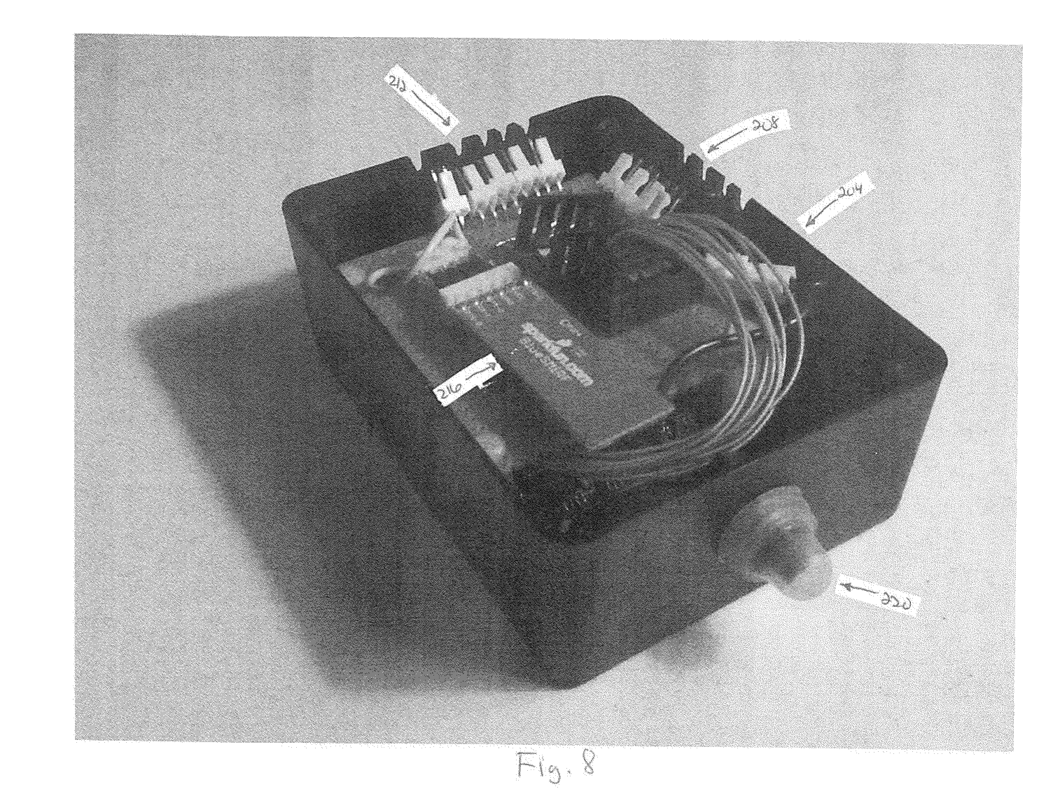

The system also includes a controller interface 204 (see FIG. 8) coupled to the shirt 20 and the electrical wires 200. The controller interface 204 includes a microcontroller or CPU (e.g., Arduino or similar 8-bit microcontroller) and a plurality battery inputs 208 electrically coupled to onboard power sources such as, for example, batteries. Additionally, the controller interface 204 includes a plurality of power outputs 212 where the electrical wires 200 associated with the illumination devices 40 may electrically couple. Moreover, the controller interface 204 includes high current rated LDO linear regulator, heat sink, and a transceiver 216 such as, for example, a Blue SMiRF Bluetooth transceiver. The controller interface 204 also includes a data output, data lines to the microcontroller or CPU for SPI and UART lines, and a reset button 220.

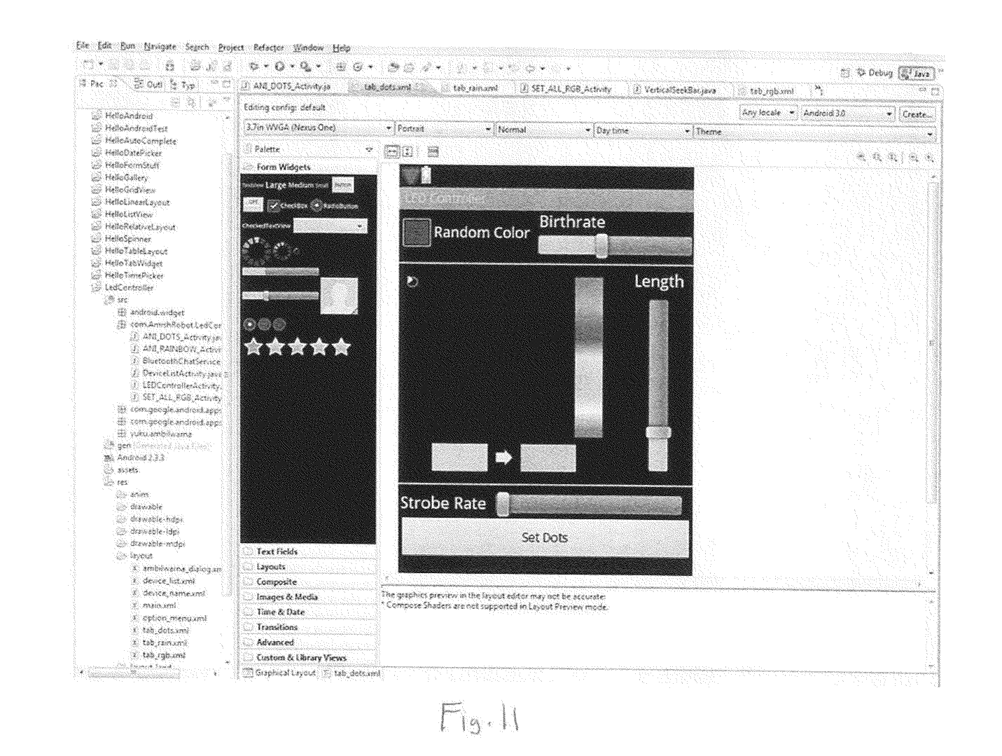

The wireless communication device 52 includes an APP stored thereon for wirelessly communicating with and controlling the operation of the shirt 20. The APP may be an Android APP, an iPhone compatible APP, or any other type of software stored on the wireless communication device 52 adapted to wirelessly communicate with and control operation of the shirt 20. An exemplary screen-shot of the APP creation is illustrated in FIG. 11. In some examples, the APP communicates to an ATmega128 via the Bluetooth transceiver 216 on the controller interface 204. The microcontroller outputs data via the SPI data lines to the electrical wires 200 and to daisy-chained shift-register-controlled constant current regulators driving the illumination devices 40 (e.g., Red-Green-Blue (RGB) LEDs). In some examples, the regulator may be a LM10841T 5 Amp 5 volt LDO linear regulator.

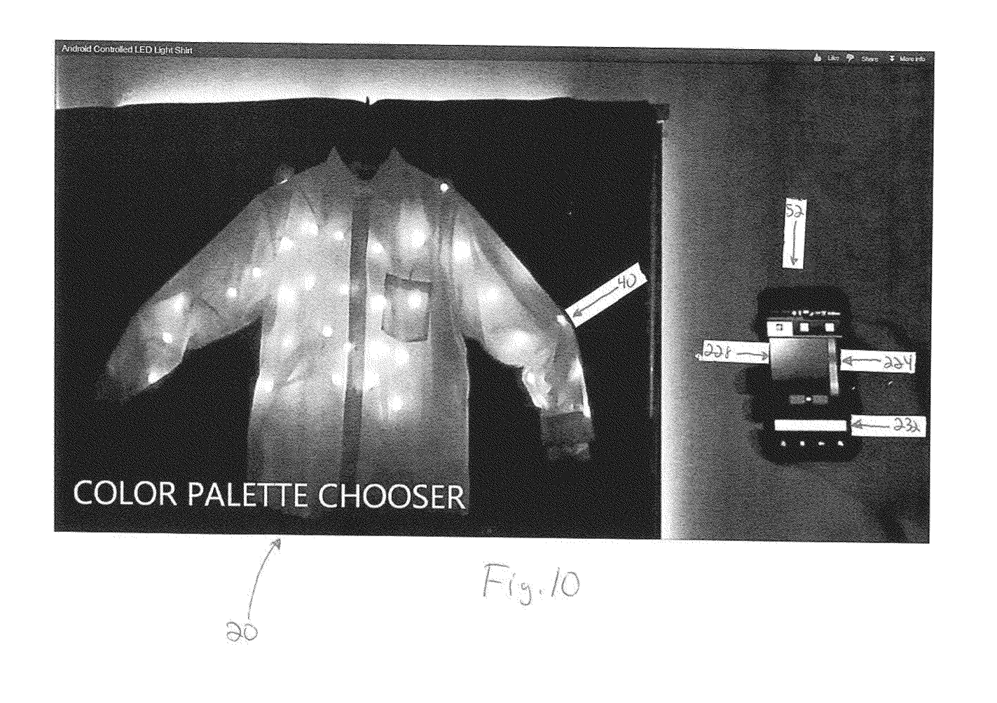

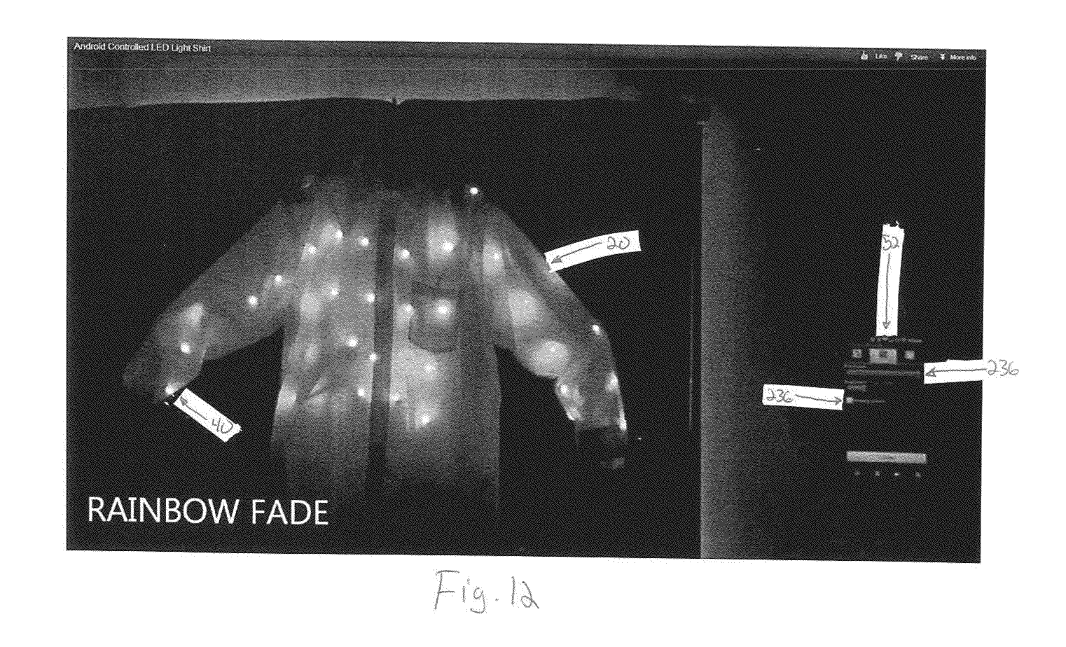

With reference to FIGS. 10 and 12, the shirt 20 is illustrated in an illuminated condition and the wireless communication device 52 displays controls on the display. The communication device 52 is adapted to display controls thereon in any configuration for controlling the shirt 20 in any manner, and all of such possibilities are intended to be within the spirit and scope of the present invention. Additionally, multiple displays may be required to provide all the controls. In the illustrated exemplary embodiment in FIG. 10, the display is touchscreen enabled and a first portion of the controls is displayed and include a color spectrum portion 224, a color activation portion 228, and an execution portion 232. The spectrum portion 224 provides a spectrum of many different colors from which to select. A user selects a desired color and the color activation portion 228 illuminates the selected color. A user selects the color activation portion 228 after it illuminates the selected color and then selects the execution portion 232, which sends a wireless signal to the transceiver 216 in the controller interface 204 of the shirt 20. The transceiver 216 receives the signal associated with the selected color and communicates data associated with the selected color to the illumination devices 40, which illuminate the selected color. This can be repeated as desired to change the color emitted by the illumination devices 40.

With particular reference to FIG. 12, the communication device 52 displays a second portion of the controls. The second portion of the controls includes a plurality of adjustable slidebars 236 that are adapted to control a variety of different operations of the shirt. Exemplary operations controlled by the slidebars 236 include, but are not limited to, fading of illumination between on and off, illumination intensity control, rate of illumination fading, rate of illumination intensity control, simultaneous illumination of a variety of colors, pulsating or flashing of the illumination devices, rate of change of pulsating or flashing of the illumination devices 40, or a variety of other operations. The communication device 52 is capable of including any number of slidebars 236 or other controls providing the desired controls of the communication device 52.

It should be understood that the communication device 52 and any software and/or APP that may be downloaded to the communication device 52 may enable the communication device 52 to communicate with any type of product 20 using any type of control language. It should also be understood that the downloadable software and/or APP may allow a user to create manners of operating products and the communication device 52 may operate products in accordance with the created operating manners. Further, it should be understood that the downloadable software and/or APP may already include predetermined manners of operating products and the communication device 52 may operate the products in the predetermined operating manners.

As indicated above, any number of products 20 may be operated in any manner. In some instances, software or APPS downloaded to the user's communication device 52 may already include a plurality of predetermined operations 64 (see FIG. 4) for controlling operation of a plurality of products 20. In such instances, a user selects the desired predetermined operation 64 and the products 20 operate accordingly. In other instances, software or APPS downloaded to the user's communication device 52 provide a user with the ability to create their own operations 64 for controlling operation of a plurality of products 20. In such instances, a user creates one or more operations 64 on the communication device 52 with the APP and stores the created operation(s) 64 in the memory 28. The user may create any number of operations 64 and select the created operations 64 on the communication device 52 as desired.

It should be understood that while the above exemplary embodiments include various types of wireless communication, the present invention may include wired communication rather than the wireless communication described above and illustrated in the drawings. Moreover, it should be understood that the present invention may include any combination of wireless and wired communications.

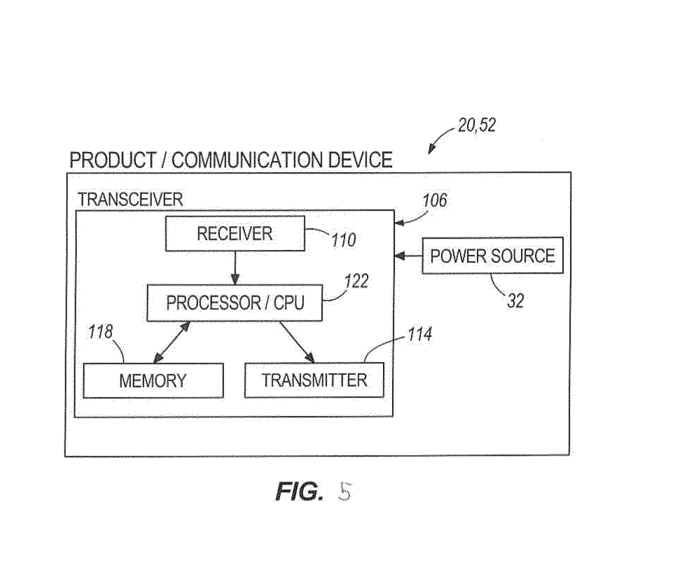

It should also be understood that the above description relating to transmitters and receivers is not intended to be limiting. Rather, other devices are capable of performing the necessary functionality to facilitate communication between devices. For example, a transceiver may be used in place of a receiver and a transmitter. In such an example, the transceiver may perform one or more of interpreting signals, translating signals, receiving signals, transmitting signals, and may include memory and a processor/CPU. In instances where the transceiver may include memory and/or a processor/CPU, the memory and processor/CPU may replace the memory and CPU in the exemplary systems. Such transceivers may be uniquely designed both in structure and functionality and incorporated into any of the exemplary systems of the present invention. Referring to FIG. 5, an exemplary product or communication device including an exemplary transceiver 106 is illustrated. This illustrated exemplary transceiver 106 is not intended to be limiting, but rather serve as an exemplary possibility of the many types of transceivers 106 contemplated for the present invention. The exemplary transceiver 106 may be included in either or both a product 20 and/or a communication device 52. The transceiver 106 may include any number of a receiver 110, a transmitter 114, memory 118, a processor or CPU 122, and any of wide variety of other elements. The transceiver 106 may be in electrical communication with the power source 32 of the product 20 and/or the communication device 52. While not illustrated, the exemplary product 20 and/or communication device 52 may include any of the other structural elements described above in connection with the product 20 and/or communication device 52. Such other structural elements have been omitted for simplicity of emphasizing the exemplary transceiver. Similarly, the exemplary product 20 and/or communication device 52 may have the same functionality of the products 20 and/or communication devices 52 described above or alternative functionality thereof.

The various systems, apparatuses, products, etc. disclosed herein and the features and functionality of such systems, apparatuses, products, etc. may be combined with any of the other systems, apparatuses, products, etc. in any combination and in any manner.

It should be understood that various exemplary types of output devices and functionality of output devices of products are described herein and such exemplary output devices and associated functionality are not intended to be limiting. Rather, the products and output devices associated with the present invention are adapted to be controlled in any manner resulting in any type of effect being performed by the products. Effects may include, but are not limited to, lighting; audio; scent; vibration, and temperature; altering intensity of lighting, audio, scent, vibration, and temperature; flashing or pulsating lighting, audio, scent, vibration, and temperature; altering flashing or pulsating of lighting, audio, scent, vibration, and temperature; moving images or video on products; scrolling text on products; choreographing or coordinating output devices no matter the structure and functionality of the output devices; or any other of a wide variety of effects.

It will be appreciated by persons skilled in the art that the present invention is not limited to what has been particularly shown and described herein above. In addition, unless mention was made above to the contrary, it should be noted that all of the accompanying drawings are not to scale. Of note, the system components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Moreover, while certain embodiments or figures described herein may illustrate features not expressly indicated on other figures or embodiments, it is understood that the features and components of the examples disclosed herein are not necessarily exclusive of each other and may be included in a variety of different combinations or configurations without departing from the scope and spirit of the invention. A variety of modifications and variations are possible in light of the above teachings without departing from the scope and spirit of the invention, which is limited only by the following claims.

What is claimed is:

1. A wearable item comprising:
a receiver;
a power source;
an illumination device adapted to illuminate a first color and a second color different than the first color; and
a processor in communication with the receiver, the power source, and the illumination device;
wherein the receiver is adapted to receive a signal and communicate the signal to the processor, and wherein the processor is configured to illuminate the illumination device in one of the first color and the second color based on the signal received by the receiver.

2. The wearable item of claim 1, wherein the receiver is adapted to receive a plurality of signals and communicate the signals to the processor, and wherein the processor is configured to illuminate the illumination device in the first color based on a first signal of the plurality of signals and illuminate the illumination device in the second color based on a second signal of the plurality of signals.

3. The wearable item of claim 1, wherein the wearable item is a shirt.

4. The wearable item of claim 1, wherein the wearable item receives the signal from a communication device including a processor and a transmitter, wherein the communication device is adapted to communicate with the wearable item to control the illumination device.

5. The wearable item of claim 4, wherein the communication device is one of a cellular phone, a smart phone, a tablet, a personal computer, and a laptop computer.

6. The wearable item of claim 4, wherein the communication device wirelessly communicates with the wearable item.

7. The wearable item of claim 4, wherein the communication device communicates with the wearable item through a wire connection.

8. A system comprising:
a wearable item including
a receiver,
a power source,
an illumination device electrically coupled to the power source, and
a processor in communication with the receiver, the power source, and the illumination device; and
a communication device including
a power source,
a transmitter, and
a processor in communication with the power source and the transmitter;
wherein the communication device is adapted to transmit a signal associated with operation of the illumination device via the transmitter, and wherein the receiver is adapted to receive the signal and the processor of the wearable item is adapted to control the illumination device in accordance with the signal.

9. The system of claim 8, wherein the wearable item is a shirt.

10. The system of claim 9, wherein the communication device is one of a cellular phone, a smart phone, a tablet, a personal computer, and a laptop computer.

11. A method of adjusting an illumination characteristic of a wearable item having a receiver, comprising:
receiving a first signal with the receiver, and
modifying an illumination characteristic of the wearable item based at least in part on the first signal.

12. The method of claim 11, wherein the illumination characteristic includes at least one of a color, brightness, pattern, flash rate, and flash intensity.

13. The method of claim 11, wherein the wearable item includes a plurality of illumination devices, and wherein modifying an illumination characteristic includes altering a condition of the plurality illumination devices.

14. The method of claim 11, wherein the wearable item is a shirt.

15. The method of claim 11, further comprising wirelessly sending the first signal from a communication device.

16. The method of claim 15, wherein the communication device is one of a cellular phone, a smart phone, a tablet, a personal computer, and a laptop computer.

17. The method of claim 11, further comprising receiving a second signal with the receiver, and modifying an illumination characteristic of the wearable item based at least in part on the second signal.
